(19) United States
(12) Patent Application Publication
(10) Pub. No.: US 2020/0401434 A1
(43) Pub. Date: Dec. 24, 2020

(54) PRECISION TIME PROTOCOL IN A VIRTUALIZED ENVIRONMENT

(71) Applicant: VMware, Inc., Palo Alto, CA (US)

(72) Inventors: VIVEK MOHAN THAMPI, BENGALURU (IN); Joseph A. Landers, Palo Alto, CA (US)

(21) Appl. No.: 16/446,139

(22) Filed: Jun. 19, 2019

(51) Int. Cl. G06F 9/455; G06F 13/42

(52) U.S. Cl. CPC G06F 9/45558; G06F 13/4221; G06F 2213/0024; G06F 2009/45583; G06F 2009/45595

(57) ABSTRACT

Disclosed are aspects of a Precision Time Protocol (PTP) implementation in a virtualized environment. A PTP daemon is executed in a VM that publishes clock parameters generated from a NIC providing a PTP stack to a shared memory space. Other VM's can obtain the clock parameters and synchronize clocks using a PTP daemon executed on the VM.

### BACKGROUND

In a virtualized environment, physical host machines can execute one or more virtual computing instances, such as virtual machines (VMs). Network Time Protocol (NTP) has been utilized as a mechanism to keep clocks synchronized among VMs on a host machine. In general, NTP can be utilized to keep clocks among VMs synchronized with precision on a scale in the milliseconds. However, certain customers or users of a virtualized environment may desire even more precise timekeeping or clock synchronization among their machines in a server environment. Accordingly, Precision Time Protocol (PTP) is a standard that has been developed to achieve nanosecond precision for clocks in a network environment. PTP utilizes hardware timestamping instead of the software timestamping that NTP utilizes, which is the reason for its ability to achieve greater precision levels and synchronization.

Hardware timestamping is typically achieved using a network interface card (NIC) that is installed on a server. However, because hardware timestamping is generally a requirement for PTP, implementing PTP in a virtualized environment can be difficult. A VM often lacks directs access to the hardware resources of a host machine in which it is being executed. Additionally, implementing PTP in the hypervisor on which the VMs are running requires additional instrumentation and complexity to be plumbed into the hypervisor. Therefore, a PTP implementation that allows VMs on a host machine to utilize PTP and create a PTP time domain is an increasing need as virtualization becomes more ubiquitous.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram illustrating an example of a host machine according to examples of the disclosure.

FIG. 2 is an example scenario according to embodiments of the disclosure.

FIG. 3 is an example scenario according to embodiments of the disclosure.

FIG. 4 is a flowchart that illustrates an example of functionalities performed by embodiments of the disclosure.

FIG. 5 is a flowchart that illustrates an example of functionalities performed by embodiments of the disclosure.

### DETAILED DESCRIPTION

Embodiments of the disclosure are directed to a Precision Time Protocol (PTP) implementation in a virtualized environment. PTP is a protocol used to synchronize clocks in a network of machines that is highly precise. Network Time Protocol (NTP) is a network time synchronization protocol that is less precise.

PTP can achieve clock accuracy in the sub-microsecond range, which can be useful for application that require highly precise time synchronization among nodes. PTP can be used to synchronize financial transactions, nodes in a network of machines rendering video, or other applications that require highly precise time synchronization. Many PTP implementations involve utilizing a network interface card (NIC) in the computing device to provide a PTP stack from which the clock is derived by a PTP implementation within the operating system of the computing device. In a virtualized environment, multiple virtual machines (VMs) can be implemented on a single physical computing device, which is also referred to as a host machine. A virtualized environment is often implemented by executing a hypervisor or an operating system that has hypervisor functionality. The hypervisor provides an abstraction layer that separates the VMs from the hardware resources of the host machine. Accordingly, providing a PTP implementation in a VM can be difficult because of this abstraction. Additionally, implementing PTP within the hypervisor can require a significant undertaking that involves modifying the hypervisor code.

Therefore, examples of this disclosure are directed to a PTP implementation that can provide PTP clock parameters to VMs running atop a hypervisor without implementing PTP within the hypervisor itself. A special purpose PTP VM or PTP appliance VM can be created atop the hypervisor that provides PTP clock parameters to other VMs on the host machine that are configured in the same PTP time domain.

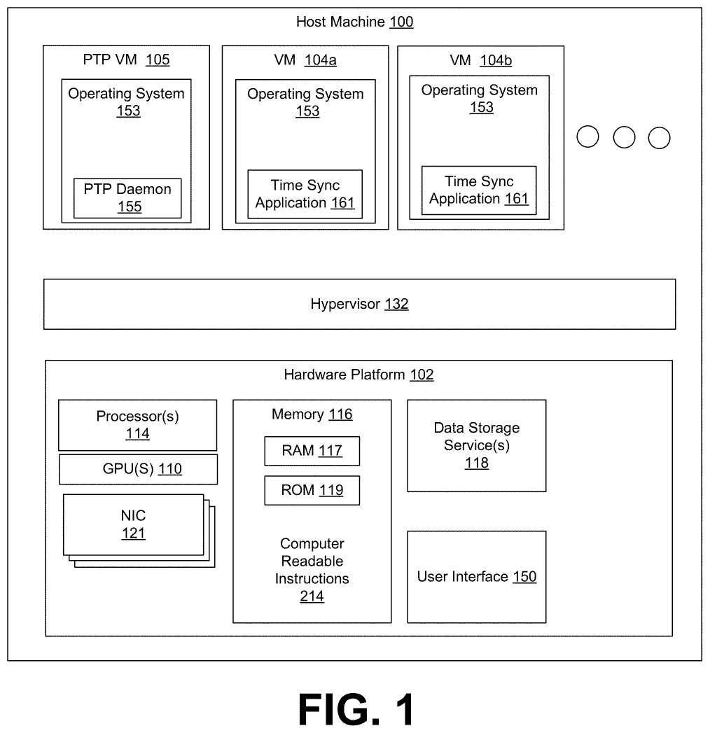

FIG. 1 is a block diagram of a host machine 100 for serving one or more virtual machines 104. The illustrated host machine 100 can be implemented as any type of host computing device, such as a server 112. The host machine 100 can be implemented as a VMWARE® ESXi host. The host machine 100 can include a host for running one or more virtual machines 104.

The host machine 100 can represent a computing device that executes application(s), operating system(s), operating system functionalities, and other functionalities associated with the host machine 100. The host machine 100 can include desktop personal computers, kiosks, tabletop devices, industrial control devices, and servers. The host machine 100 can be implemented as a blade server within a rack of servers. Additionally, the host machine 100 can represent a group of processing units or other computing devices.

The host machine 100 can include a hardware platform 102. The hardware platform 102 can include one or more processor(s) 114, memory 116, and at least one user interface, such as user interface component 150. The processor(s) 114 can include any quantity of processing units and can execute computer-executable instructions for implementing the described functionalities. The instructions can be performed by the processor or by multiple processors within the host machine 100 and can be performed by a processor external to the host machine 100.

The memory 116 can include media associated with or accessible by the host machine 100. The memory 116 can include portions that are internal to the host machine 100, external to the host computing device, or both. In some examples, the memory 116 can include a random access memory (RAM) 117 and read only memory (ROM) 119. The RAM 117 can be any type of random access memory. The RAM 117 can be part of a shared memory architecture. In some examples, the RAM 117 can include one or more cache(s). The memory 116 can include stores one or more computer-executable instructions 214.

The host machine 100 can include a user interface component 150. In some examples, the user interface can simply be a keyboard and/or mouse that allows an administrator to interact with the hardware platform 102. For example, to diagnose or configure the host machine 100 while physically present at the rack, the administrator might utilize a keyboard, mouse, and display.

The hardware platform 102 can also include at least one network interface component, or network interface card (NIC) 121. The NIC 121 can include firmware or computer-executable instructions that operate the NIC 121. The firmware on the NIC can provide a PTP stack that allows for a PTP implementation on a computing device in which the NIC is installed. PTP relies on hardware assistance such as PTP aware network switches and hardware timestamping capabilities in NICs. Hardware timestamping in the network card in particular lends to significant improvements in time synchronization accuracies by eliminating delay variations in the network stack. Typically, PTP network packets are identified by the network interface at the MAC or PHY layer, and a high precision clock onboard the NIC is used to generate a timestamp corresponding to the ingress or egress of the PTP synchronization packet. The timestamps can be made available to the time synchronization daemon or PTP implementation in an operating system executed by a device in which the NIC is installed.

The data storage device(s) 118 can be implemented as any type of data storage, including, but without limitation, a hard disk, optical disk, a redundant array of independent disks (RAID), a solid state drive (SSD), a flash memory drive, a storage area network (SAN), or any other type of data storage device. In some examples, the data storage device(s) 118 provide a shared data store. A shared data store is a data storage accessible by two or more hosts in a host cluster. In some implementations, a virtual storage area network (vSAN) that is implemented on a cluster of host machines 100 can be used to provide data storage resources for VMs 104 executed on the host machine.

The host machine 100 can host one or more virtual computing instances, such as, VMs 104a and 104b as well as PTP VM 105. A VM 104 can execute an operating system 153 as well as other applications, services, or processes as configured by a user or customer. For example, a VM 104 can execute applications that perform financial transactions, provide virtual desktop infrastructure (VDI) environments for users, perform security and user authentication, or perform any other functions that a physical computing device might be called upon to perform. Additionally, although only two VMs 104 are illustrated, a host machine 100 can execute more or fewer VMs 104 depending upon the scenario.

The host machine 100 can execute a hypervisor 132. The hypervisor 132 can be a type-1 hypervisor, which is also known as a bare-metal or native hypervisor that includes and integrates operating system components that can operate the hardware platform 102 directly, such as a kernel. The hypervisor 132 can be implemented as a VMware ESX/ESXi hypervisor from VMware, Inc. The hypervisor 132 can include software components that permit a user to create, configure, and execute VMs 104, such as the PTP VM 105, on the host machine 100. The VMs 104 can be considered as running on the hypervisor 132 in the sense that the hypervisor 132 provides an abstraction layer between the operating system 153 of the VM 104 and the hardware components in the hardware platform 102. For example, the hypervisor 132 can provide a virtual NIC, virtual storage, virtual memory, and other virtualized hardware resources to the operating system 153 of a VM 104, which can convenient for many reasons and smooth the deployment and management of VMs 104 in comparison to a fleet of physical servers.

However, owing to this virtualized environment, fully virtualizing a PTP implementation to extend high-precision clock synchronization to the VMs 104 running on a hypervisor 132 poses significant challenges. A naive solution would extend all virtual networking elements with PTP support, such as adding PTP awareness to the virtual switch, adding virtual hardware timestamping capabilities to the virtual NIC provided by the hypervisor 132 to VMs 104, and so on. However, since virtual networking through the hypervisor 132 is based in software, adding PTP awareness to it would ultimately be limited by the overhead and inherent delay variations of the virtual network stack of the hypervisor 132. While such a solution may improve upon NTP, the achievable accuracy and precision would be limited compared hardware timestamping based solutions. Fully virtualizing PTP also requires that the networking stack of the hypervisor 132 support hardware timestamping capabilities and include the necessary drivers for the NICs. Additionally, given that multiple virtual machines can share the same underlying clock, it is computationally wasteful for each VM 104 to perform time synchronization as opposed to performing it once on the host machine 100 or for a given PTP time domain. This can result in decreased performance offered by the hypervisor 132 to the VMs 104 because of the computing resources that are consumed by these respective PTP implementations.

Examples of this disclosure can overcome many of the above shortfalls and the above challenges. By utilizing a type-1 hypervisor 132, embodiments of the disclosure can leverage features that are often built into the hypervisor 132, such as a peripheral component interconnect (PCI) pass-through feature that permits the hypervisor 132 to direct assign a hardware component to one of the VMs 104, such as the PTP VM 105, that are running atop the hypervisor 132. Accordingly, a PTP compliant NIC 121 can be direct assigned to the PTP VM 105 utilizing a PCI pass-through or hardware direct assignment feature of the hypervisor 132 that permits direct assignment of hardware resources of the hardware platform 102 to a VM running atop the hypervisor 132.

The PTP VM 105 can be created, configured, and executed to run a PTP daemon 155. The PTP daemon 155 can be an off-the-shelf PTP implementation that runs within the operating system 153 with which the PTP VM 105 is configured. For example, PTPd, ptpd2, and ptpv2d are examples of PTP implementations that can be run within Linux or Unix-based operating systems 153. The PTP daemon 155 can also be a customized PTP implementation that interacts with a NIC 121 to generate clock parameters from which the system clock of the PTP VM 105 and other VMs 104 can be synchronized. The hypervisor 132 can be configured to direct assign a NIC 121 providing a PTP stack to the PTP VM 105. Other VMs 104 running on the hypervisor 132 can be assigned a virtual NIC, which can rely on other NICs in the hardware platform 102. In other words, the PTP VM 105 can be exclusively assigned a NIC 121 providing a PTP stack from which PTP time parameters can be derived. Accordingly, the PTP daemon 155 on the PTP VM 105 can be configured to derive one or more time or clock parameters from the a clock signal or hardware timestamp provided by the NIC 121 that is direct assigned to the PTP VM 105.

The PTP daemon 155 can generate one or more clock parameters from data obtained from the NIC 121 and publish them to other VMs 104 that are running atop the hypervisor 132 and that are on the same PTP time domain. Publishing the PTP clock parameters can be accomplished using a memory sharing feature of the hypervisor 132 whereby one or more pages of memory can be shared among VMs 104 and appear to the VMs 104 as a portion of their own memory. Therefore, if the PTP daemon 155 writes data to a portion or page of memory that is setup by the hypervisor 132 to be shared with other VMs 104, the data appears in the memory of the other VMs 104 and can be used to derive a clock within each of the respective VMs 104 by a corresponding PTP daemon 155 executed by those VMs 104.

As noted above in the context of the NIC 121, the hypervisor 132 can present the operating system 153 of a VM 104a with a virtual hardware platform. The virtual hardware platform can include virtualized processor 114, memory 116, user interface device 150 and networking resources. VMs 104, which can include the PTP VM 105, can also execute applications, which can communicate with counterpart applications or services such as web services accessible through a network. The applications can communicate with one another through virtual networking capabilities provided by the hypervisor 132 to their respective operating systems 153 in which they are executing. The applications can also utilize the virtual memory and CPU resources provided by the hypervisor 132 to their respective operating systems 153 in which they are executing.

A VM 104 can execute a time sync application 161. The time sync application 161 can obtain clock parameters generated by the PTP daemon 155 and published to other VMs 104 on the same PTP time domain. The time sync application 161 can also discipline or synchronize the system clock of a VM 104 on which it is executing using the clock parameters published by the PTP daemon 155 so that the PTP VM 104 and other VMs 104 on the same time domain are synchronized.

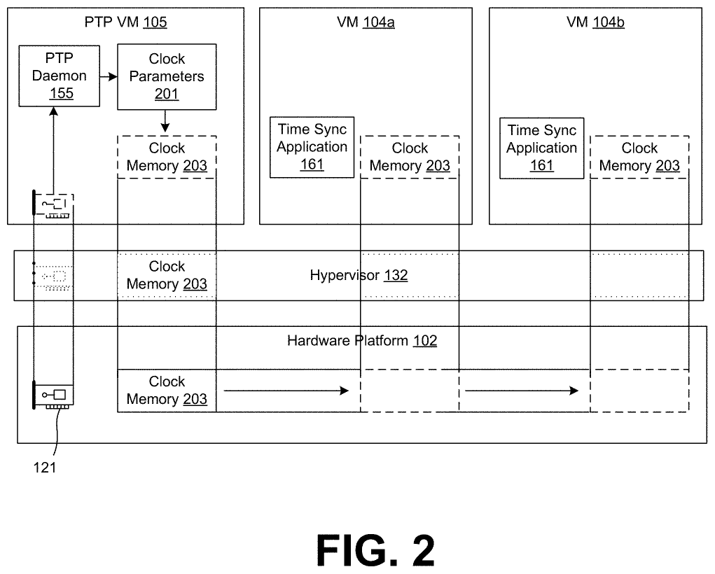

Continuing to FIG. 2, shown is a drawing that illustrates how implementing PTP in a virtualized environment is accomplished according to this disclosure. As shown in FIG. 2, a PTP VM 105 can be executed atop a hypervisor 132 along with other VMs 104a, 104b, that are in the same PTP time domain. Accordingly, the PTP VM 105 can generate PTP clock parameters 201 that are generated with the aid of a NIC 121 direct assigned to the PTP VM 105 through the hypervisor 132. The PTP clock parameters 201 are published to a portion of memory that is shared with the VMs 104a, 104b so that they can derive their system clocks, counters, or other local information based upon a PTP time signal. As a result, PTP can be implemented in this virtualized environment without significant retooling or recoding of the hypervisor 132.

As shown in FIG. 2, a NIC 121 that provides a PTP stack can be installed in the hardware platform 102. The NIC 121 can be one of several NICs 121 installed in the hardware platform 102 that are accessible to the hypervisor to provide network capabilities to VMs 104. The NIC 121 direct assigned to the PTP VM 105 need not be the same NIC that the hypervisor 132 relies upon to provide virtual networking capabilities to the PTP VM 105 for other purposes. In other words, the NIC 121 can be assigned to the PTP VM 105 solely for interfacing with the PTP daemon 155 and generating clock parameters 201, a system clock, and other derivations of a hardware timestamping of the NIC 121.

The NIC 121 can be direct assigned to the PTP VM 105 using a PCI pass-through functionality of the hypervisor 132 so that the PTP VM 105 can use the MC 121 as a native device. The operating system 153 of the PTP VM 105 can use a NIC driver to control the NIC 121 and make it available as a device that the PTP daemon 155 can interact with to derive a system clock or parameters from which a system clock can be derived. Accordingly, the pass-through operation can allow exclusive assignment of the PTP VM 105 to the NIC 121.

The PTP VM 105 and other VMs 104 on the same PTP time domain can be created and configured to share a portion or page of memory, referred to as the clock memory 203. The clock memory 203 can be shared using the hypervisor 132 so that data written by the PTP VM 105 to the clock memory 203 appears as written to the memory of the other VMs 104a, 104b. The clock memory 203 can be shared using a shared memory feature of the hypervisor 132. The other VMs 104a, 104b, can also be configured to run a time sync application 161, which can be configured on those VMs 104a, 104b, to obtain time parameters from the clock memory 203 and synchronize their respective system clocks based on the parameters in the clock memory 203. The time sync application 161 can be implemented as a protocol agnostic time synchronization software that is configured to discipline the system clock of the VM 104a or 104b according to the parameters in the clock memory 203. The time sync application 161 can be configured to run alongside or with an in the VM 104 that takes parameters from the clock memory 203 and feeds them into the time sync application 161, which can in turn adjust the system clock based on the parameters. The parameters in the clock memory 203 need not always be PTP time parameters if another protocol is desired.

The PTP daemon 155 executed by the PTP VM 105 can be configured to utilize data from the NIC 121, such as a hardware timestamp, to periodically generate clock parameters 201 or set a system clock of the PTP VM 105. In this way, an off-the-shelf PTP daemon 155 can be utilized so that a custom PTP implementation is not required. The PTP daemon 155 can obtain the clock parameters 201 and distribute them to other VMs 104 executed by the host machine 100 that are on the same PTP time domain. The clock parameters 201 are distributed to the other VMs 104a, 104b, by writing them to the clock memory 203. In some examples, the PTP daemon 155 can also write a string that identifies the PTP time domain.

The clock parameters 201 generated by PTP VM 105 can be generated in a fashion that is agnostic to a particular time synchronization protocol such as PTP. The clock parameters 201 can include a multiplier and a shift value applied to a common clock shared by all VMs 104 and the host machine 101 and can be referred to as a reference clock.

The PTP daemon 155 executed by the VMs 104a, 104b, that are on the same time domain can be configured to obtain the PTP time parameters, or the clock parameters 201, that are based on the hardware timestamping data provided by the NIC 121 to the PTP daemon 155 on the PTP VM 105. Because the clock parameters 201 are written to the clock memory 203 that is shared among members of the PTP time domain, their respective time sync applications 161 can generate their system clocks using the same clock parameters 201, resulting in precise time synchronization among members of the PTP time domain.

The NIC 121 can be direct assigned to the PTP VM 105 using a PCI pass-through functionality of the hypervisor 132 so that the PTP VM 105 can use the MC 121 as a native device. The operating system 153 of the PTP VM 105 can use a NIC driver to control the NIC 121 and make it available as a device that the PTP daemon 155 can interact with to derive a system clock or parameters from which a system clock can be derived. Accordingly, the pass-through operation can allow exclusive assignment of the PTP VM 105 to the NIC 121.

The PTP VM 105 and other VMs 104 on the same PTP time domain can be created and configured to share a portion or page of memory, referred to as the clock memory 203. The clock memory 203 can be shared using the hypervisor 132 so that data written by the PTP VM 105 to the clock memory 203 appears as written to the memory of the other VMs 104a, 104b. The clock memory 203 can be shared using a shared memory feature of the hypervisor 132. The other VMs 104a, 104b, can also be configured to run the time sync application 161, which can be configured on those VMs 104a, 104b, to obtain PTP time parameters from the clock memory 203.

The PTP daemon 155 executed by the PTP VM 105 can be configured to utilize data from the NIC 121, such as a hardware timestamp, to periodically generate clock parameters 201 or set a system clock of the PTP VM 105. The clock parameters 201 generated by the PTP daemon 155 can be distributed by the PTP daemon 155 to other VMs 104 executed by the host machine 100 that are on the same PTP time domain. The clock parameters 201 are distributed to the other VMs 104a, 104b, by writing them to the clock memory 203. In some examples, the PTP daemon 155 can also write a string that identifies the PTP time domain to the clock memory 203.

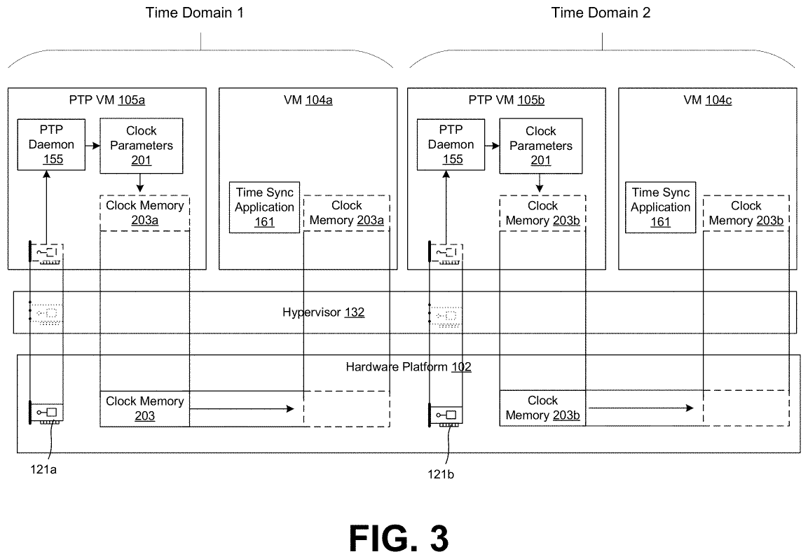

Referring next to FIG. 3, shown is a scenario in which multiple PTP time domains can be possible on a single host machine 100 according to embodiments of the disclosure. To support multiple time domains, the host machine 100 can be configured to execute multiple PTP VMs 105a and 105b. More than two PTP VMs 105 can be executed to support more than two PTP time domains on a single host machine 100. In the example of FIG. 3, each PTP VM 105a, 105b, can be assigned its own NIC 121a, 121b, respectively, for the purpose of communicating with the PTP daemon 155 in the PTP VM 105a, 105b.

The NICs 121a and 121b can be direct assigned to the PTP VMs 105a and 105b, respectively, also using a PCI pass-through functionality of the hypervisor 132 so that the PTP VMs 105 can use their respective NICs 121 as native devices. The operating system 153 of the PTP VMs 105 can use a NIC driver to control the NICs 121 and make it available as a device that the PTP daemon 155 can interact with to derive a system clock or parameters from which a system clock can be derived. Accordingly, the pass-through operation can allow exclusive assignment of the PTP VM 105 to the NIC 121.

The PTP VM 105a and 105b as well as other VMs 104a and 104c on the same PTP time domain can be created and configured to share a portion or page of memory, referred to as the clock memory 203a, and 203b. In the example of FIG. 3, Time Domain 1 corresponds to PTP VM 105a and VM 104a, and Time Domain 2 corresponds to PTP VM 105b and VM 104c. The clock memory 203a, 203b can be shared among members of common PTP time domains using the hypervisor 132 so that data written by the PTP VM 105 to the clock memory 203 appears as written to the memory of the other VMs 104 in the same PTP time domain. The clock memory 203 can be shared using a shared memory feature of the hypervisor 132. The other VMs 104, can also be configured to run the time sync application 161, which can be configured on those VMs 104a, 104c, to obtain PTP time parameters from the clock memory 203a or 203b. The time sync application 161 executed by a VM 104 can be configured to identify its PTP time domain based upon a string that identifies the PTP time domain that is written to the clock memory.

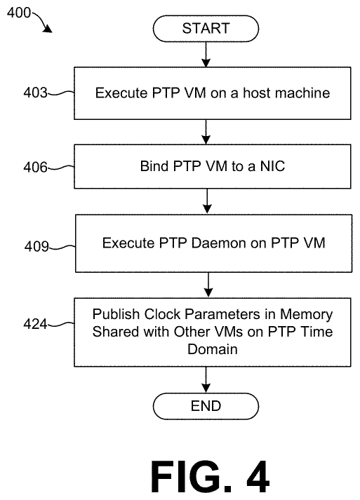

FIG. 4 shows an example flowchart 400 describing steps that can be performed by components in the host machine 100. Generally, the flowchart 400 describes how components in the host machine 100, such as the PTP daemon 155, can publish clock parameters 201 to other VMs 104 on the same PTP time domain.

First, at step 403, a PTP VM 105 can be executed on a host machine 100. The PTP VM 105 can be a special purpose or appliance VM that is created to implement PTP on the host machine 100. The PTP VM 105 can be configured by a user or administrator to run a PTP daemon 155 that can synchronize clock parameters 201 among VMs 104 on the same PTP time domain.

At step 406, the PTP VM 105 can be bound to a NIC 121 within the host machine 100. By utilizing a type-1 hypervisor 132, embodiments of the disclosure can leverage a PCT pass-through feature that permits the hypervisor 132 to direct assign a hardware component to one of the VMs 104 that are running atop the hypervisor 132. Accordingly, a PTP compliant NIC 121 can be direct assigned to the PTP VM 105 utilizing a PCI pass-through or hardware direct assignment feature of the hypervisor 132 that permits direct assignment of hardware resources of the hardware platform 102 to the PTP VM 105.

Next, at step 409, the PTP daemon 155 can be executed on the PTP VM 105. The PTP daemon 155 can be configured to generate clock parameters 201 using the NIC 121. The clock parameters 201 can include fields that are related to the PTP protocol and from which the PTP daemon 155 can synchronize a system clock of the PTP VM 105. The PTP daemon 155 can perform a timestamp transformation to the clock parameters 201 to generate a system clock, which can result in highly precise time that can be synchronized among members of the PTP time domain. In some implementations, the clock parameters 201 need not be PTP-specific. Instead, the parameters can generally describe how to transform a shared host clock to arrive at the current precise time. Accordingly, the PTP daemon can obtain or generate the clock parameters 201 that can be published to the clock memory 203, where other VMs 104 on the same PTP time domain obtain the clock parameters 201.

At step 424, the PTP daemon 155 can publish the clock parameters 201 to the clock memory 203. Publishing the clock parameters 201 can be accomplished using a memory sharing feature of the hypervisor 132 whereby one or more pages of memory can be shared among VMs 104 and appear to the VMs 104 as a portion of their own memory. Therefore, if the PTP daemon 155 writes data to a portion or page of memory that is setup by the hypervisor 132 to be shared with other VMs 104, the data appears in the memory of the other VMs 104 and can be used to derive a clock within each of the respective VMs 104 by a corresponding time sync application 161 executed by those VMs 104. Additionally, the PTP daemon 155 can publish a string that identifies the PTP time domain of the PTP VM 105 in the clock memory 203. Thereafter, the process can proceed to completion.

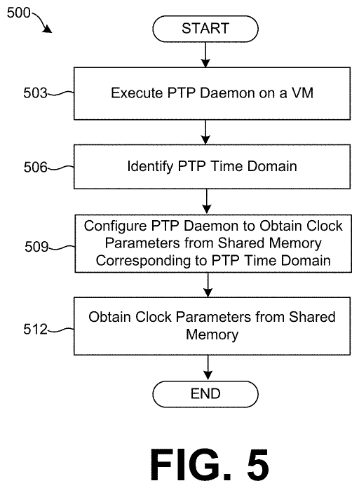

FIG. 5 shows an example flowchart 500 describing steps that can be performed by components in the host machine 100. Generally, the flowchart 500 describes how components in the host machine 100, such as the time sync application 161 in a VM 104, can obtain clock parameters 201 from the PTP VM 105 on the same PTP time domain.

First, at step 503, a time sync application 161 can be executed on the VM 104. The time sync application 161 can be an off-the-shelf PTP implementation or a time synchronization application that runs within the operating system 153 with which the VM 104 is configured. For example, PTPd, ptpd2, and ptpv2d are examples of PTP implementations that can be run within Linux or Unix-based operating systems 153. Chrony is an example implementation of a more generalized time synchronization application that can synchronize a system block with PTP servers, NTP servers, other reference clocks, or time parameters that are stored in memory. Accordingly, the time synchronization application 161 can be configured or pointed to the clock memory 203 to obtain time parameters with which the system clock of the VM 104 can be synchronized.

At step 506, the VM 104 can be configured to identify a PTP time domain with which the VM 104 is synchronized. The PTP time domain can be entered by an administrator user into an agent on the VM 104. Additionally, the administrator can configure the VM 104 and/or the hypervisor 132 to share the clock memory 203 among the VMs 104 on the PTP time domain and the PTP VM 105.

At step 509, the time sync application 161 can be configured to obtain clock parameters 201 from the clock memory 203 and derive a clock signal or system clock from the clock memory 203.

At step 512, the time sync application 161 can obtain the clock parameters 201 from the clock memory 203. The clock parameters 201 are published to the clock memory 203 by the PTP daemon 155 on the PTP VM 105 using a memory sharing feature of the hypervisor 132 whereby one or more pages of memory can be shared among VMs 104 and appear to the VMs 104 as a portion of their own memory. Therefore, if the PTP daemon 155 writes data to a portion or page of memory that is setup by the hypervisor 132 to be shared with other VMs 104, the data appears in the memory of the other VMs 104 and can be used to derive a clock within each of the respective VMs 104 by a corresponding PTP daemon 155 executed by those VMs 104. Additionally, the PTP daemon 155 can publish a string that identifies the PTP time domain of the PTP VM 105 in the clock memory 203. Thereafter, the process can proceed to completion.

The flowcharts of FIGS. 4-5 show examples of the functionality and operation of implementations of components described herein. The components described herein can include hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts of FIGS. 4-5 show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all variations are within the scope of the present disclosure.

The components described herein can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as magnetic, optical, semiconductor, or other suitable media. Examples of a suitable computer-readable media include, but are not limited to, solid-state drives, magnetic drives, and flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All modifications and variations are intended to be included herein within the scope of this disclosure.

Therefore, the following is claimed:

1. A computer-implemented method, comprising:
executing a precision time protocol (PTP) virtual machine (VM) on a host machine, the host machine comprising a physical network interface card (NIC), the PTP VM executed by a hypervisor on the host machine;
binding the PTP VM to the physical NIC through the hypervisor, wherein the PTP VM is provided direct access to the physical NIC through the hypervisor;
executing a PTP daemon on an operating system executed by the PTP VM;
configuring the PTP daemon implementing the PTP daemon on the PTP VM to generate at least one PTP time parameter based on the direct access to the physical NIC;
obtaining the at least one PTP time parameter from the PTP daemon; and
publishing the at least one PTP time parameter into a portion of memory of the PTP VM, wherein the portion of memory of the PTP VM is shared with other VMs executed by the host machine that are within a common PTP time domain as the PTP VM.

2. The computer-implemented method of claim 1, wherein another VM executed by the PTP VM is configured to derive a local clock on the other VM from the at least one PTP time parameter published in the portion of memory of the PTP VM.

3. The computer-implemented method of claim 1, wherein the portion of memory of the PTP VM is shared using a memory sharing feature of the hypervisor.

4. The computer-implemented method of claim 1, wherein the at least one PTP time parameter comprises a string identifying a time domain associated with the PTP VM.

5. The computer-implemented method of claim 1, wherein binding the PTP VM to the physical NIC further comprises linking the PTP VM and the physical NIC using a peripheral component interconnect (PCI) pass-through feature of the hypervisor.

6. The computer-implemented method of claim 1, wherein another VM executed by the host machine utilizes a virtual NIC for network accessibility rather than the physical NIC, wherein the virtual NIC relies upon a different physical NIC in the host machine.

7. The computer-implemented method of claim 6, further comprising:
executing a second PTP VM on the host machine, the host machine comprising a second physical NIC, the second PTP VM executed by the hypervisor on the host machine;
binding the second PTP VM to the second physical NIC through the hypervisor, wherein the PTP VM is provided direct access to the physical NIC through the hypervisor;
executing a second PTP daemon on an operating system executed by the second PTP VM;
configuring the second PTP daemon to implement PTP on the PTP VM;
obtaining a second at least one PTP time parameter from the PTP daemon; and
publishing the second at least one PTP time parameter into a portion of memory of the second PTP VM, wherein the portion of memory of the second PTP VM is shared with other VMs executed by the host machine that are within a second PTP time domain.

8. A system, comprising:
a host machine comprising at least one processor, the host machine configured to at least:
execute a precision time protocol (PTP) virtual machine (VM) on the host machine, the host machine comprising a physical network interface card (NIC), the PTP VM executed by a hypervisor on the host machine;
bind the PTP VM to the physical NIC through the hypervisor, wherein the PTP VM is provided direct access to the physical NIC through the hypervisor;
execute a PTP daemon on an operating system executed by the PTP VM;
configure the PTP daemon implementing the PTP daemon on the PTP VM to generate at least one PTP time parameter based on the direct access to the physical NIC;
obtain the at least one PTP time parameter from the PTP daemon; and
publish the at least one PTP time parameter into a portion of memory of the PTP VM, wherein the portion of memory of the PTP VM is shared with other VMs executed by the host machine that are within a common PTP time domain as the PTP VM.

9. The system of claim 8, wherein another VM executed by the PTP VM is configured to derive a local clock on the other VM from the at least one PTP time parameter published in the portion of memory of the PTP VM.

10. The system of claim 8, wherein the portion of memory of the PTP VM is shared using a memory sharing feature of the hypervisor.

11. The system of claim 8, wherein the at least one PTP time parameter comprises a string identifying a time domain associated with the PTP VM.

12. The system of claim 8, wherein binding the PTP VM to the physical NIC further comprises linking the PTP VM and the physical NIC using a peripheral component interconnect (PCI) pass-through feature of the hypervisor.

13. The system of claim 8, wherein another VM executed by the host machine utilizes a virtual NIC for network accessibility rather than the physical NIC, wherein the virtual NIC relies upon a different physical NIC in the host machine.

14. The system of claim 13, wherein the host machine is further configured to at least:
execute a second PTP VM on the host machine, the host machine comprising a second physical NIC, the second PTP VM executed by the hypervisor on the host machine;
bind the second PTP VM to the second physical NIC through the hypervisor, wherein the PTP VM is provided direct access to the physical NIC through the hypervisor;
execute a second PTP daemon on an operating system executed by the second PTP VM;
configure the second PTP daemon to implement PTP on the PTP VM;
obtain a second at least one PTP time parameter from the PTP daemon; and
publish the second at least one PTP time parameter into a portion of memory of the second PTP VM, wherein the portion of memory of the second PTP VM is shared with other VMs executed by the host machine that are within a second PTP time domain.

15. A non-transitory computer-readable medium embodying code executable by a host machine, the code causing the host machine to at least:
execute a precision time protocol (PTP) virtual machine (VM) on the host machine, the host machine comprising a physical network interface card (NIC), the PTP VM executed by a hypervisor on the host machine;
bind the PTP VM to the physical NIC through the hypervisor, wherein the PTP VM is provided direct access to the physical NIC through the hypervisor;
execute a PTP daemon on an operating system executed by the PTP VM;
configure the PTP daemon implementing the PTP daemon on the PTP VM to generate at least one PTP time parameter based on the direct access to the physical NIC;
obtain the at least one PTP time parameter from the PTP daemon; and
publish the at least one PTP time parameter into a portion of memory of the PTP VM, wherein the portion of memory of the PTP VM is shared with other VMs executed by the host machine that are within a common PTP time domain as the PTP VM.

16. The non-transitory computer readable medium of claim 15, wherein another VM executed by the PTP VM is configured to derive a local clock on the other VM from the at least one PTP time parameter published in the portion of memory of the PTP VM.

17. The non-transitory computer readable medium of claim 15, wherein the portion of memory of the PTP VM is shared using a memory sharing feature of the hypervisor.

18. The non-transitory computer readable medium of claim 15, wherein binding the PTP VM to the physical NIC further comprises linking the PTP VM and the physical NIC using a peripheral component interconnect (PCI) pass-through feature of the hypervisor.

19. The non-transitory computer readable medium of claim 15, wherein another VM executed by the host machine utilizes a virtual NIC for network accessibility rather than the physical NIC, wherein the virtual NIC relies upon a different physical NIC in the host machine.

20. The non-transitory computer readable medium of claim 19, wherein the code, when executed by the host machine, further cause the host machine to at least:
execute a second PTP VM on the host machine, the host machine comprising a second physical NIC, the second PTP VM executed by the hypervisor on the host machine;
bind the second PTP VM to the second physical NIC through the hypervisor, wherein the PTP VM is provided direct access to the physical NIC through the hypervisor;
execute a second PTP daemon on an operating system executed by the second PTP VM;
configure the second PTP daemon to implement PTP on the PTP VM;
obtain a second at least one PTP time parameter from the PTP daemon; and
publish the second at least one PTP time parameter into a portion of memory of the second PTP VM, wherein the portion of memory of the second PTP VM is shared with other VMs executed by the host machine that are within a second PTP time domain.
